(19) United States
(12) Patent Application Publication
(10) Pub. No.: US 2022/0056790 A1
(43) Pub. Date: Feb. 24, 2022

(54) POUR POINT AVOIDANCE IN OIL/WATER PROCESSING AND TRANSPORT

(71) Applicant: EQUINOR ENERGY AS, Stavanger (NO)

(72) Inventors: Arild SAMUELSBERG, Haugesund (NO); Cecilie Gotaas JOHNSEN, Trondheim (NO); Jostein SOGGE, Stjørdal (NO)

(21) Appl. No.: 17/415,516

(22) PCT Filed: Dec. 18, 2019
(86) PCT No.: PCT/NO2019/050282

§ 371 Date: Jun. 17, 2021

(30) Foreign Application Priority Data
Dec. 18, 2018 (GB) 1820634.2

(51) Int. Cl. E21B 43/12; E21B 43/20; F17D 1/17

(52) U.S. Cl. CPC E21B 43/12; F17D 1/17; E21B 43/20

(57) ABSTRACT

A method of producing a fluid from a hydrocarbon well, the fluid comprising an emulsion of water and oil and where the proportion of water (water cut) varies over time. The method comprises: determining whether the water cut of the produced fluid is within the oil/water inversion range; and when the water cut is within the oil/water inversion range, adding water to the produced fluid in order to increase its water cut to above the oil/water inversion range. Thus, the fluid produced transitions from the water-in-oil phase to the oil-in-water phase without (at least significantly) entering the inversion phase.

The present invention relates to a method and system for producing fluid comprising an emulsion of oil and water from a hydrocarbon well, and in particular to the avoidance of conditions in which the flow of produced fluid from the well may be inhibited because the emulsion enters its inversion range. Other aspects of the invention address other situations in which the flow of produced fluid may be inhibited.

It is well known that the fluid produced from a hydrocarbon well may contain a significant amount of water in addition to oil and gas. Furthermore, the proportion of water, known as the water cut, typically increases over time as the oil in the reservoir that is being exploited is extracted. This process may be accelerated by enhanced oil recovery techniques where water is injected into the reservoir in order to maintain formation pressure.

As oil and water are immiscible, the mixture of them in the produced fluid forms an emulsion where tiny droplets of one liquid are suspended in the other. Where the liquid is mostly oil, this is a water-in-oil emulsion and vice versa for an oil-in-water emulsion.

Under most conditions, both water-in-oil (w/o) and oil-in-water (o/w) emulsions flow easily. However, there is an ‘inversion range’ at the range of water cut values at the transition between the two sorts of emulsion. This typically occurs when the water cut is between 50% and 70%.

The oil/water inversion range therefore refers to an inversion phase of the fluid, a phenomenon that occurs when an agitated oil in water emulsion reverts to water in oil and vice versa. This is undesirable as the produced fluid is very viscous in this phase, resulting in difficulties with pumping, controlling flow rate and processing. Under certain conditions, particularly where the hydrocarbon has a high paraffin content, this may associated with a pour point—i.e. the temperature below which a fluid no longer flows. In other words, under such conditions the emulsion may not flow at all when in the inversion phase.

This problem is to be distinguished from other factors that are known to inhibit the flow of produced hydrocarbons, such as the formation of hydrates. Indeed, the present invention is particularly concerned with conditions where hydrate formation is unlikely.

According to a first aspect of the present invention, there is provided a method of producing a fluid from a hydrocarbon well, the fluid comprising an emulsion of water and oil, where the proportion of water (water cut) varies over time, the method comprising: determining whether the water cut of the produced fluid is within the oil/water inversion range; and when the water cut is within the oil/water inversion range, adding water to the produced fluid in order to increase its water cut to above the oil/water inversion range.

The invention is applicable to the common scenario whereby the water cut of produced fluid from a well increases over time, particularly as water is injected into the well as part of an enhanced oil recovery procedure. By means of the invention, as the water cut increases, it is monitored and the inversion range is avoided entirely by addition of water to the produced fluid before the water cut rises into the inversion range. Thus, the fluid transitions from the water-in-oil phase to the oil-in-water phase without (at least significantly) entering the inversion phase.

The invention is particularly useful when the conditions are such that the inversion phase corresponds to the pour point—i.e. where the fluid is at a temperature at which it would cease to flow in the inversion phase. However, it is also applicable in other, less critical, conditions.

As noted above, this is an entirely separate issue from the problem of hydrate formation and the invention is particularly useful where the produced fluid is outside the range of pressures and temperatures required to cause hydrate formation in the produced fluid.

The invention is particularly applicable to offshore oil production and accordingly, the water added to the produced fluid is preferably seawater. The seawater may be treated, for example to remove sulphur, before it is added to the produced fluid, in order to avoid contamination of the hydrocarbon products.

The added water may be provided from any suitable source and may be provided only for the above purpose. However, as noted above, the invention is particularly useful where water injection is employed and accordingly its source may also be used for water injection into the formation associated with the hydrocarbon well.

The water may be added at any convenient location, but it should preferably be close to the wellhead to provide the greatest benefit. Accordingly water is preferably added to the produced fluid at a location between a production wellhead and a production riser leading to a platform.

The produced fluid may also contain gas. Preferably, at least some gas is removed from the produced fluid at a platform. Moreover, at least some of the removed gas may be used as fuel at the platform.

One application of the invention is to remote systems, such as unmanned platforms, exploiting satellite wells some distance from a host platform, vessel or other host. Accordingly, at least oil and water from the produced fluid may be transported as a mixed fluid to a remote location. The transported fluid may also contain gas, in which case the conditions may be maintained such that the gas remains in solution—i.e. the fluid is at least semi-stabilised.

In order to ensure that the produced fluid does not enter the inversion range, water may be added to the produced fluid if it is determined that the produced fluid would otherwise have a water cut of between 50% and 70%. However, other water cut percentages may be used as appropriate, depending upon the conditions under which the inversion phase occurs for the particular produced fluid.

Typically, the invention will be used over a significant period of time, typically many years, e.g. corresponding to the lifetime of a production facility. Thus, initially the produced fluid can be expected to have a very low water cut, though this may increase fairly quickly over a few years. Accordingly, the produced fluid is typically produced for at least a year (and usually for several years) before water is added to it.

However, following a further period (of perhaps years), the water cut of the produced fluid will have increased into the oil-in-water phase range and so it becomes no longer necessary to add water. Accordingly, it is preferred that, following a period of time during which water is added, it is determined that the water cut will be above the oil/water inversion range and subsequently ceasing to add water.

The invention also extends to an apparatus (referred to here as a system) for performing the method(s) described above.

Thus, according to a further aspect of the invention there is provided a system for producing a fluid from a hydrocarbon well comprising an emulsion of water and oil, the system comprising: means for monitoring the proportion of water (water cut) over time; means for determining whether the water cut of the produced fluid is within the oil/water inversion range; and means for controlling a flow of water for mixing with the produced fluid such that, when the water cut is within the oil/water inversion range water is added to the produced fluid in order to increase its water cut to above the oil/water inversion range.

Preferably, the emulsion of water and oil is produced from a wellhead on the seabed and flows to a first conduit and the water is provided by a source of seawater and flows to a second conduit, there being provided a third conduit connecting the first and second conduits and having a flow control valve therein.

Preferably, a controller is provided to control the flow control valve whereby the flow of seawater into the first conduit may be controlled. More generally, the controller is preferably arranged to perform the method(s) described above, and particularly the preferred forms thereof.

The invention also provides a method, which is useful when a well is to be shut down. In such a case, fluids within the system will cool down and may cause flow blockages.

Accordingly, viewed from a still further aspect, there is provided a method of operating a system for producing a fluid from a hydrocarbon well, the fluid comprising an emulsion of water and oil, where the proportion of water (water cut) varies over time, the method comprising: ceasing production of the fluid, determining whether already produced fluid within the system is within conditions that may cause it to at least partially solidify; and adding water to the produced fluid in order to increase its water cut. Preferably the added water is introduced into a production riser after shutdown of production of hydrocarbons from the well.

Accordingly, the produced fluid in the production riser, processing apparatus on board a platform and/or transport pipelines and/or any other associated conduits through which it flows will be displaced by fluid that will not partially or entirely solidify during the anticipated shut-down conditions. This may be done by adding only sufficient water to take the fluid out of the inversion range. However, under certain conditions it may be necessary to add sufficient water to avoid the fluid reaching a pour point under other conditions. Indeed, if necessary or appropriate, the produced fluid could be entirely replaced by water in some or all of the conduits and components referred to above.

Indeed, this concept may be useful regardless of the condition of the produced fluid (i.e. regardless of water cut, inversion range, etc.). Thus, viewed from a still further aspect, the invention provides a method of shutting down production of produced fluid, wherein water is injected into the production riser in order to displace produced fluid therefrom and from apparatus and conduits downstream thereof, in order to prevent the whole or partial solidification of produced fluid therein during shutdown.

In either of these embodiments, the injected water may be removed downstream using conventional separators when production is resumed.

An embodiment of the invention will now be described, by way of example only, and with reference to the accompanying drawings, in which:

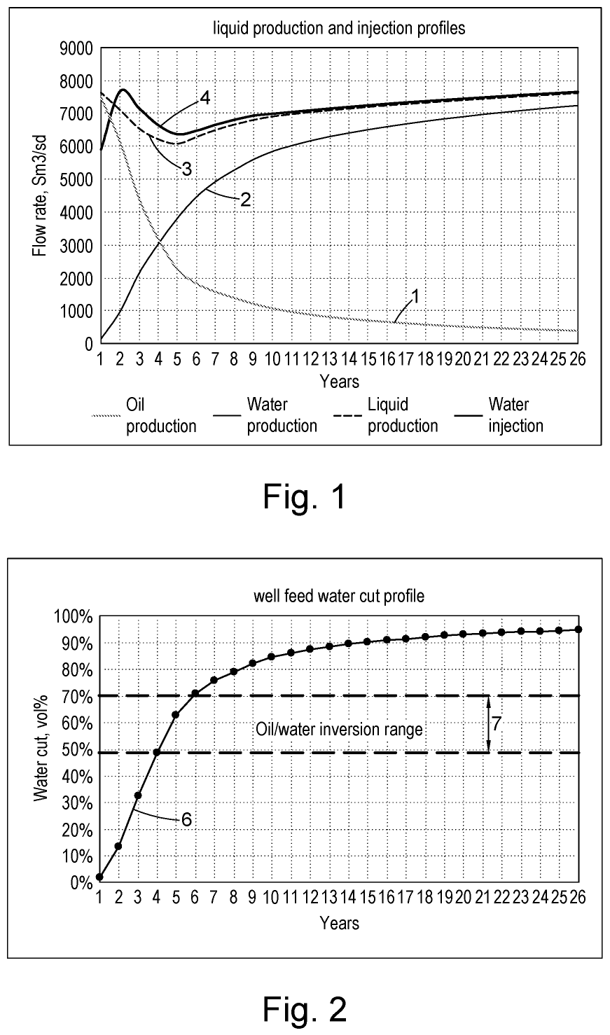

FIG. 1 is a graph showing liquid production and injection profiles plotted against time of a hydrocarbon well where the invention may be employed;

FIG. 2 is a well feed water cut profile plotted against time for the well of FIG. 1;

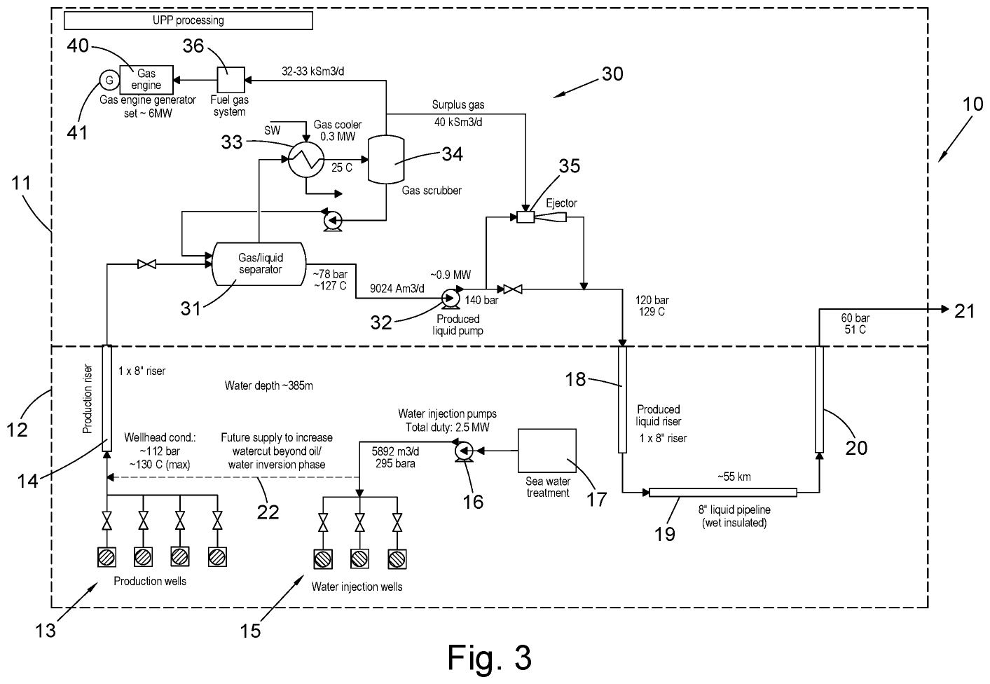

FIG. 3 is a schematic fluid flow diagram showing the production features, processing features (on a local Unmanned Production Platform), and injection features of an embodiment of the present invention in a first configuration;

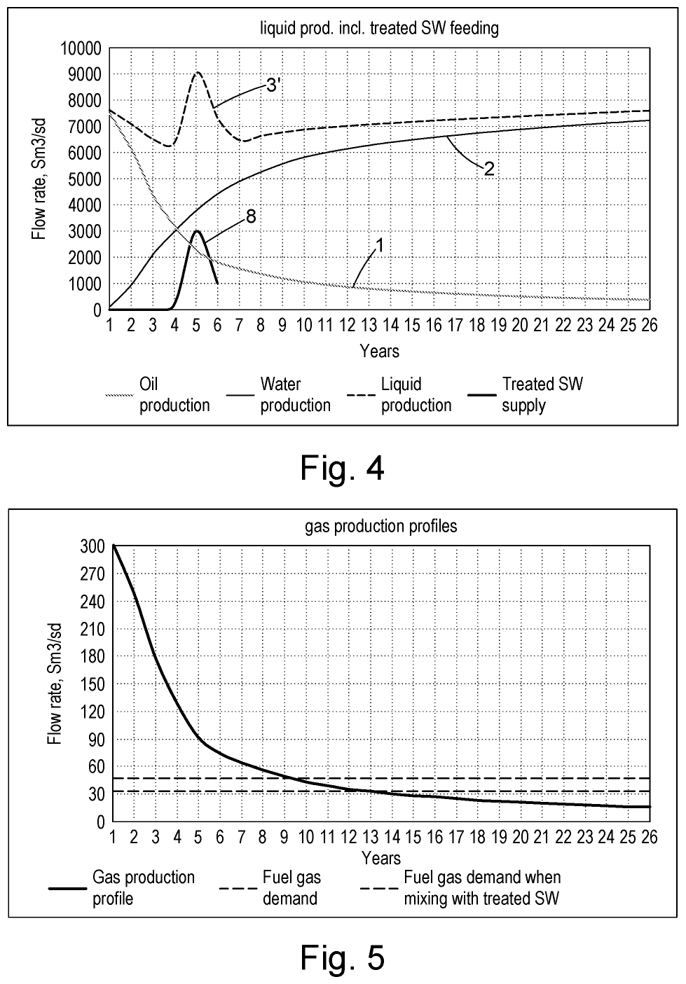

FIG. 4 is a graph showing liquid production profiles plotted against time for the hydrocarbon well of claim 1 where an embodiment of the invention is employed;

FIG. 5 is a gas production profile against time for the well of FIG. 1; and

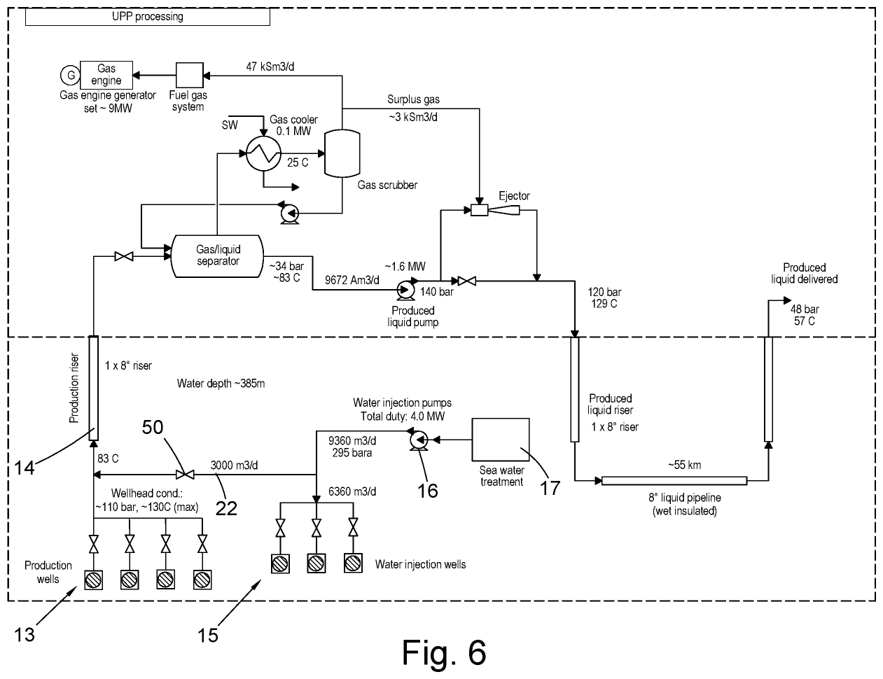

FIG. 6 is a diagram corresponding to FIG. 3 showing a second configuration.

The embodiment concerns the production of hydrocarbons at a remote unmanned production platform from which it is desired to transport a semi-stabilised produced fluid comprising oil, gas and water to a remote host platform or other facility for processing. Produced gas is also used as fuel for a gas engine powered generator to power the apparatus on the platform.

Referring first to FIG. 1, there is provided a graph in which oil production 1, water production 2, liquid production (i.e. oil plus water) 3, and water injection 4 are shown for the first twenty-six years of production from a hydrocarbon well where the embodiment may be employed.

It will be noted that the oil production starts at a relatively high level which drops rapidly over the first seven years or so of production to roughly a seventh of the original level before decreasing much less rapidly over the remaining lifetime of the well. The water production rate increases in a roughly complementary manner over the same periods with the result that total liquid production is much less variable.

For completeness, FIG. 5 shows the gas production profile over the time. This is discussed below in relation to its use as fuel.

The well uses water injection to support formation pressure and hence enhance oil recovery. There is a relatively steep increase in water injection over the first year of production, followed by a decline to a minimum at about five years, which corresponds to minimum liquid production and then a gentle increase for the remaining lifetime of the well.

The profile of the water cut 6 of the produced liquid 3 over the same period is shown in FIG. 2. The water cut is the percentage of water by volume in the total liquid and it corresponds to the ratio of produced water 3 to produced oil 2. Thus, it is initially close to 0%, but rises quickly as the oil production 1 decreases.

This figure also shows the oil/water inversion range 6 at a water cut of between 50% and 70%, which in this case (which is typical for such a well) the produced fluid enters between years 4 to 6 of production

The oil/water inversion region 7 refers to an inversion phase of the fluid, a phenomenon that occurs when an agitated oil-in-water emulsion reverts to water-in-oil and vice versa. Under certain conditions, this is associated with a pour point—i.e. a temperature below which the liquid will no longer flow. In crude oil, a high pour point (temperature) is generally associated with a high paraffin content. (Accordingly, the embodiments are most useful when there is a high paraffin content.)

This condition is undesirable because the produced fluid is very viscous, resulting in difficulties with pumping, controlling flow rate and processing. In this phase, the fluid also has a high wax temperature (the temperature below which precipitates begin to form in the liquid).

In the illustrated embodiment, the problematic conditions are avoided by using the apparatus 10 of FIG. 3 to modify the effective liquid production profile as shown in FIG. 4.

Referring to FIG. 4, it will be noted that the oil production profile 1 and the water production profile 2 correspond to those of FIG. 1. However, during years four to six, treated seawater 8 is supplied to the produced fluid so that the effective liquid production 3′ (i.e. the produced liquids plus the supplied treated seawater) has the profile shown in the figure.

Thus, as will be described in more detail below, the treated seawater is pumped directly to the manifold of the well or production riser in order to “dilute” the produced fluid that passes through the system and increase the water cut to >70%, thereby avoiding the oil/water inversion region and phase.

Considering FIG. 2, this can be imagined as a step-change in year 4 from a water cut of below 50% straight up to a water cut of above 70%, such that the inversion range, and hence the pour point, is entirely avoided.

An embodiment of the invention that provides this effect is shown in FIGS. 3 and 6, with FIG. 3 showing a ‘normal’ configuration and FIG. 6 showing the configuration used when seawater is supplied to the produced fluid.

Referring to FIG. 3, the top half of the figure illustrates components provided on an unmanned production platform (UPP) 11 and the lower half to components located between it and the seabed. Four production wellheads 13 are located at the seabed in communication with a subsea hydrocarbon reservoir. They are connected via valves (Christmas tree, BOP, etc.) and conduits in the conventional manner to production riser 14, leading to the UPP 11.

In addition, water injection wellheads 15 are also in communication with the reservoir. The may be connected via a conduit 22 to water injection pumps 16 (one illustrated), which is in turn connected to a seawater treatment unit 17, which receives and treats seawater for injection. In this figure, the conduit is shown as a dotted line, indicating that it is either absent or not in use.

Also shown in the region 12 beneath the UPP are a produced liquid riser which connects the UPP 11 to a subsea 8 inch wet insulated liquid pipeline 19 of around 55 km in length, which leads via a further riser 20 to a remote host platform or other facility 21.

Turning now to the UPP 11, this hosts separation apparatus 30 and a gas engine 40.

The separation apparatus includes a gas/liquid separator 31, which has a liquid outlet leading to produced liquid pump 32 and then the produced liquid riser 18. The gas outlet of the separator 31 leads via gas cooler 33 to gas scrubber 34 and then to fuel gas system 36, which supplies the gas engine 40 connected to generator 41. A surplus gas line leads from gas scrubber 34 via ejector 35 to the produced liquid riser 18. A liquid line leads from gas scrubber 34 back to the gas/liquid separator 31

In operation, oil is produced from production wells passes through wellheads 13 and rises up the production riser 14 to the separation apparatus 30 on the UPP. Here, the produced fluid enters the gas/liquid (two phase) separator 31, which separates natural gas from the oil and water. The oil and water passes to the produced liquid pump, down produced liquid riser, along the liquid pipeline (in this case 55 km) to a remote processing facility. The liquid enters the riser 18 at 120 bar and 129° C. and leaves it at 60 bar and 51° C. As such, it flows as a single phase liquid.

The gas separated in the gas/liquid separator 31 is cooled/condensed in the gas cooler 33, and passed through the gas scrubber 34 to remove any remaining liquid. Any liquid separated at this stage is returned to the gas/liquid separator 31.

The gas is then passed to fuel gas system 36 where it is used to drive gas engine 40, which is connected to generator set 41. This generates the required electrical power at the oil field. Any surplus gas can be passed through the ejector 35 and dissolved in the liquid for transport via the pipeline 19 to the processing facility.

Seawater is treated at the seawater treatment system 17 to be suitable for injection into the well (typically removing sulphur). This treated water is then pumped by injection pumps 16 to the water injection wellheads 15, where it is injected into the reservoir to support the reservoir pressure in the known manner.

As noted above, a dotted line 22 between the water injection flow and the production riser flow indicates where a supply of treated water may be provided to feed into the manifold/production riser. This is done when necessary to increase the water cut of the produced fluid when required to avoid the oil/water inversion range of the water cut associated with the pour point temperature of the produced fluid.

FIG. 6 corresponds to FIG. 3, except that conduit 22 is connected to provide a flow path for seawater. In addition, control valve 50 is provided so that the conduit may selectively be opened and the flow controlled as required. (Suitable control apparatus may be provided at the UPP for this purpose.) Thus, a controlled flow of sea water may flow from sea water treatment unit 17 via water injection pumps 16 and conduit 22 to production riser 14.

Thus, this figure shows the production well system is it would be during year 5, when the produced liquid would otherwise be in the inversion phase. Accordingly, the system operates as described above in relation to FIG. 3, except that the water is supplied to production riser 14 to increase the water cut to above 70%. A flow of approximately 300 m³/day flows through this to the production riser (or manifold) in order to increase the water cut of the produced fluid to around 75%. Water injection into the reservoir for pressure support is also continued as before.

As noted above, FIG. 4 shows the flow rates of the total produced liquid 3, produced oil 1 and produced water 2, along with the seawater supply 8 from the sea water treatment unit 17 when it is used to increase the water cut of the produced fluid.

This arrangement has the advantage that the processing and transport equipment for the produced fluid can be simplified as it no longer has to handle an inversion phase of the fluid. For example, the transport pipeline no longer needs to be heated as the fluid will maintain a lower wax temperature than that of the inversion phase such that hydrates do not form at the temperature of the unheated pipeline.

This system is also useful in the case of a shutdown of the well regardless of the water cut. This is because during shutdown, produced fluid is no longer removed from the well, so the temperature of the processing system and transport pipeline typically drops as the warm produced fluid is no longer passing through it. This results in the condensates forming from the remnants of produced fluid that are in the system and can result in blockages etc. Accordingly, using the system of FIG. 6, treated seawater may be passed to the manifold or production riser as described above to increase water cut of the produced fluid and this seawater supply can be maintained even when the well is shut down. As a result, treated water is constantly flushing out the processing system and transport pipeline and this prevents any blockages. Furthermore, the water can be heated and used as a heat transfer medium to maintain the temperature of the processing system and transport pipeline, thus avoiding a temperature drop and associated formation of hydrates.

1. A method of producing a fluid from a hydrocarbon well, the fluid comprising an emulsion of water and oil and where the proportion of water (water cut) varies over time, the method comprising: determining whether the water cut of the produced fluid is within the oil/water inversion range; and when the water cut is within the oil/water inversion range, adding water to the produced fluid in order to increase its water cut to above the oil/water inversion range.

2. A method as claimed in claim 1, wherein the produced fluid is outside the range of pressures and temperatures required to cause hydrate formation in the produced fluid.

3. A method as claimed in claim 1 or 2, wherein the water added to the produced fluid is seawater.

4. A method as claimed in claim 3, wherein the seawater is treated, for example to remove sulphur.

5. A method as claimed in any preceding claim, wherein the added water is provided from a source that is also used for water injection into the formation associated with the hydrocarbon well.

6. A method as claimed in any preceding claim, wherein water is added to the produced fluid at a location between a production wellhead and a production riser leading to a platform.

7. A method as claimed in any preceding claim, wherein at least some gas is removed from the produced fluid at a platform.

8. A method as claimed in claim 7, wherein at least some of the removed gas is used as fuel at the platform.

9. A method as claimed in any preceding claim, wherein at least oil and water from the produced fluid are transported as a mixed fluid to a remote location.

10. A method as claimed in any preceding claim, wherein water is added to the produced fluid if it is determined that the produced fluid would otherwise have a water cut of between 50% and 70%.

11. A method as claimed in any preceding claim wherein the produced fluid is produced for at least a year before water is added to it.

12. A method as claimed in any preceding claim, wherein following a period of time during which water is added, it is determined that the water cut will be above the oil/water inversion range and subsequently ceasing to add water.

13. A system for producing a fluid from a hydrocarbon well comprising an emulsion of water and oil, the system comprising: means for monitoring the proportion of water (water cut) over time; means for determining whether the water cut of the produced fluid is within the oil/water inversion range; and means for controlling a flow of water for mixing with the produced fluid such that, when the water cut is within the oil/water inversion range water is added to the produced fluid in order to increase its water cut to above the oil/water inversion range.

14. A system as claimed in claim 13, wherein the emulsion of water and oil is produced from a wellhead on the seabed and flows to a first conduit and the water is provided by a source of seawater and flows to a second conduit, there being provided a third conduit connecting the first and second conduits and having a flow control valve therein.

15. A system as claimed in claim 14, wherein a controller is provided to control the flow control valve whereby the flow of seawater into the first conduit may be controlled.

16. A system as claimed in claim 15, wherein the controller is arranged to perform the method of claim 1.

17. A method of operating a system for producing a fluid from a hydrocarbon well, the fluid comprising an emulsion of water and oil and where the proportion of water (water cut) varies over time, the method comprising: ceasing production of the fluid, determining whether already produced fluid within the system is within conditions that may cause it to at least partially solidify; and adding water to the produced fluid in order to increase its water cut.

18. A method as claimed in claim 17, wherein added water is introduced into a production riser after shutdown of production of hydrocarbons from the well.

19. A method of shutting down production of produced fluid, wherein water is injected into the production riser in order to displace produced fluid therefrom and from apparatus and conduits downstream thereof, in order to prevent the whole or partial solidification of produced fluid therein during shutdown.
